(19) United States
(12) Patent Application Publication
(10) Pub. No.: US 2002/0013899 A1
(43) Pub. Date: Jan. 31, 2002

(54) Automated document distribution and transaction verification

(76) Inventor: Jacob Joel Faul, Vista, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/883,625

(22) Filed: Jun. 18, 2001

Related U.S. Application Data
(60) Provisional application No. 60/212,299, filed on Jun. 17, 2000.

(51) Int. Cl. H04L 9/00

(52) U.S. Cl. 713/156; 705/75

(57) ABSTRACT

This invention relates to the generation and distribution of documents and verification of electronic transactions. In one embodiment, some elements of an electronically conducted transaction are attached to a certificate template. Essential elements of the transaction are encrypted by a first encryption process and attached to the certificate template. The resulting transaction certificate is optionally encrypted by a second encryption process and sent to the other party of the transaction. The other party decrypts the transaction certificate using a first decryption process to review the decrypted certificate. The other party may further decrypt the encrypted essential elements of the transaction certificate using a second decryption process in order to verify the transaction. The decrypted essential elements are used to prove the transaction. A third party can also decrypt the encrypted essential elements to authenticate the transaction.

### CROSS REFERENCE TO RELATED APPLICATIONS

This invention claims priority under 35 U.S.C. 119(e) from U.S. provisional application No. 60/212,299, filed Jun. 17, 2000 and titled “Automated generation and verification of a self-contained document.”

### BACKGROUND

1. Field of the Invention

Aspects of the invention relate to the generation and distribution of documents and the verification of electronic transactions.

2. Description of the Related Technology

Documents can be distributed electronically, providing benefits of speed and convenience. For example, a customer can fill out an on-line form specifying a stock purchase order, and send the form to an on-line brokerage firm, using the Internet or an Intranet, through wired or wireless connections. The brokerage firm can send a confirmation document containing the information entered by the customer back to the customer. A bank or credit card company can send financial statements to its customers electronically. Security measures are needed to ensure that the document can only be viewed by the intended recipient, but not unauthorized third parties. Security measures are also needed so that the recipient can be assured that the document indeed came from the sender, and not other parties. Measures are further needed so that a recipient has a confirmation document containing the essential information to prove the transaction and to allow third parties to use the confirmation document to authenticate the transaction.

Public key infrastructure (PKI) cryptography is a popular approach for ensuring electronic distribution security. Each party is assigned a pair of keys: a public key and a private key. The public key is generally available to the public, and the private key is held in private by the owner. It is computationally unfeasible to deduce the private key from the public key. A message encrypted with a public key can be decrypted with the corresponding private key, but cannot be feasibly decrypted with the public key. To verify that a message originates from the true sender, the sender encrypts the message with her private key, and sends the message to the recipient. The recipient uses the sender's public key to decrypt the message. If the message is successfully decrypted, the identity of the sender is verified, because only a message encrypted with the sender's private key is likely to be successfully decrypted with the sender's public key. To ensure that only the intended recipient can view a message, the sender encrypts the message with the recipient's public key, and sends the message to the recipient. The recipient decrypts the message using his private key. Since only the recipient has his private key and since the encrypted message can only be feasibly decrypted with the recipient's private key, the recipient is assured that the content of the message remains private. A detailed description of public key cryptography is provided at pp.29-51, Applied Cryptography, Bruce Schneier, 1994, ISBN 0-471-59756-2 (Applied Cryptography hereinafter).

An increasing number of transactions are being conducted electronically. A vendor typically provides a vendee with a confirmation number to confirm the transaction. The vendor stores the transaction information in its database, indexed by the confirmation number. The vendee relies on the vendor's trustworthiness to adhere to the terms of the transaction. The vendee also relies on the vendor to maintain the transaction information in the database. If the vendor is dishonest, if a miscommunication occurred between the vendor and the vendee, or if transaction information stored at the vendor database is lost or corrupted, it will be very difficult for the vendee to prove the terms of the transaction.

### SUMMARY OF THE INVENTION

This invention relates to methods and systems of using an encrypted code to verify a transaction. A transaction is conducted between a vendor and a vendee. The terms of the transaction are defined by transaction elements, which include essential elements and non-essential elements. Essential elements are preferably defined as elements that prove the essential terms of the transaction. The essential elements can be defined by the vendor, the vendee, or the vendor and vendee jointly upon consultation. They are also referred to as selected elements, as selected elements can include elements that are not indispensable to the transaction, or preclude elements that are indispensable to the transaction. The essential (or selected) elements are encrypted to generate an encrypted code, which is attached to a hard copy or electronic copy of a transaction certificate, to be sent to the vendee. The transaction certificate can optionally be encrypted by a second encryption process to prevent unauthorized parties from viewing the content of the certificate. The encrypted code can be decrypted by the vendee or another authenticating party to prove the transaction, including proving the essential terms of the transaction, and proving that the vendor was a party to the transaction. PKI algorithms are preferably used, although symmetric key algorithms can also be used for encryption and decryption.

One aspect of the invention relates to a method of verifying a transaction conducted between a first party and a second party, the method including receiving transaction elements of the transaction, identifying at least a portion of the received transaction elements as selected elements, attaching at least a portion of the received transaction elements to a certificate template, encrypting the selected elements based on a private key of the first party to generate an encrypted code, attaching the encrypted code to the certificate template to produce a transaction certificate, transmitting the transaction certificate with the encrypted code to the second party, and instructing the second party to decrypt the encrypted code of the transaction certificate based on a public key of the first party to generate decrypted selected elements, wherein the decrypted essential elements can be used by the second party to prove the transaction.

Another aspect of the invention relates to a method of verifying a transaction conducted between a first party and a second party, the method including transmitting transaction elements of the transaction to the first party, receiving a transaction certificate that includes an encrypted code, retrieving a public key of the first party, and decrypting the included encrypted code based on the retrieved public key of the first party to generate decrypted proof elements, wherein the decrypted proof elements are used to prove the transaction. The decrypted poof elements are preferably those elements that define the essential terms of the transaction.

Still another aspect of the invention relates to a method of a third party authenticating a transaction conducted between a first party and a second party, the method including receiving a transaction certificate with an encrypted code, retrieving a public key of the first party, decrypting the encrypted code based on the retrieved public key of the first party to generate decrypted proof elements, and declaring the transaction including the decrypted proof elements as authenticated if the decrypting is successful. The decrypted poof elements are preferably those elements that define the essential terms of the transaction.

### BRIEF DESCRIPTION OF THE DRAWINGS

FIG. 1 illustrates one embodiment of a verification process of using a transaction certificate to verify a transaction.

FIG. 2 illustrates one embodiment of a transaction document that is used in the process of FIG. 1.

FIG. 3 illustrates one embodiment of a certificate template that is used in the process of FIG. 1.

FIG. 4 illustrates one embodiment of a transaction certificate that is produced from the certificate template shown in FIG. 3.

FIG. 5 illustrates one embodiment of an encrypted transaction certificate that is generated from the transaction certificate shown in FIG. 4.

FIG. 6 illustrates one embodiment of an authentication process of using a third party to authenticate a transaction.

FIG. 7 illustrates one embodiment of a vendor computer and a vendee computer configured to enable the verification process of FIG. 1.

### DETAILED DESCRIPTION OF CERTAIN ILLUSTRATIVE EMBODIMENTS

The following detailed description describes certain specific embodiments of the present invention. However, the present invention may be embodied in other ways as defined and covered by the claims. In this description, reference is made to the drawings wherein like parts are designated with like numerals throughout.

Using Transaction Certificate to Verify a Transaction

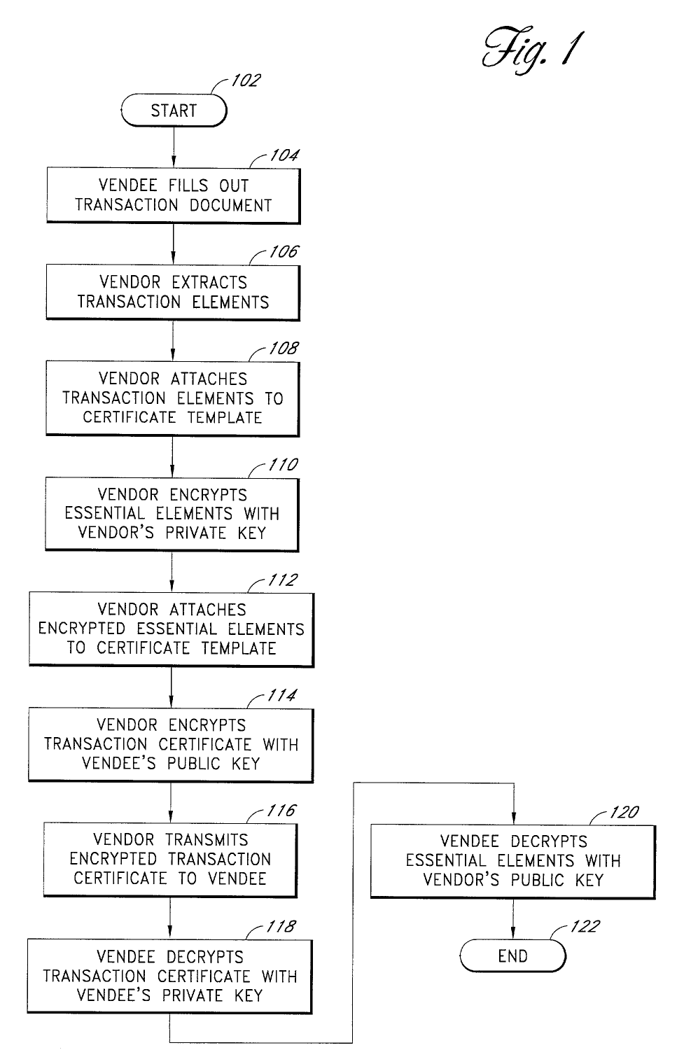

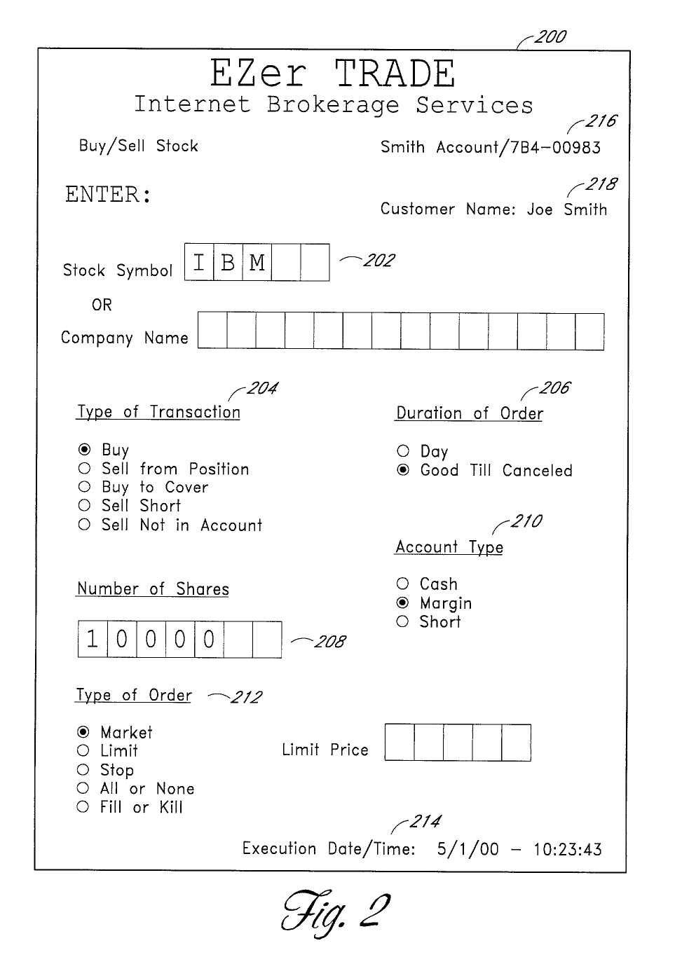

FIG. 1 illustrates one embodiment of a verification process of using a transaction certificate to verify a transaction. A transaction is initiated over a network-based system, such as the Internet or an Intranet. The transaction can be initiated by a user using a computer, a personal digital assistant, a telephone including a wireless phone, or another networked device. The transaction can take on many different forms. Typically, a transaction will involve E-commerce, a bargained for exchange of goods or services over the Internet. However, it is not limited to E-commerce. The transaction could involve, for instance, charitable donations or simply the gathering of information over the Internet. The transaction can include any activity where data is exchanged or unilaterally submitted to another party. Referring to FIG. 1, the verification process starts from start block 102 and proceeds to block 104, where the vendee fills out a transaction document 200 (FIG. 2) on-line.

In one embodiment, a transaction document 200, preferably with data fields, is used for vendee's entering and vendor's collecting transaction elements. For example, the user (referred to as the vendee) contacts an on-line broker (referred to as the vendor) to complete a transaction of stock purchase. The vendee fills out an on-line transaction document 200, which includes data fields such as “amount number”, “type of transaction (buy/sell)”, “name of stock”, “amount of transaction”, and so forth. The transaction document 200 can be in a format supported by an Internet web browser, such as Portable Document Format (PDF), Hyper Text Markup Language (HTML), Extensible Markup Language (XML), etc. The transaction elements include the essential transaction elements and non-essential elements. In one embodiment, the essential transaction elements pertain to those terms collected from the transaction document that prove the transaction, therefore essential elements include the terms necessary to re-create the transaction as it originally occurred. Non-essential elements may include terms that are not necessary to prove the transaction. By way of example, in an E-commerce transaction involving the sale of goods, the elements may include: the product ID of the product to be purchased by the vendee, price, quantity, billing information, shipping information, and a text description of the product. In one embodiment, all of the above terms except the product description are defined as essential transaction elements. The product description is defined as non-essential element, because the product ID is sufficient to identify the product of the transaction. Depending on the embodiment, the essential elements and non-essential elements can be defined by the vendor, by the vendee, or by the vendor and vendee through consultation. For example, a vendor and a vendee who are frequent business partners may agree to define only the price as essential element, or to define only the price, the product ID, and the quantity to be essential elements.

FIG. 2 illustrates one embodiment of a transaction document 200. The transaction document 200 of FIG. 2 is an on-line form for a stock transaction through an online brokerage service. The transaction elements include the stock symbol 202, type of transaction 204, duration of order 206, the number of shares 208, account type 210, type of order 212, the date and time of execution 214, the customer's account number 216 and the customer name 218. In one embodiment, all the above terms except the customer name 218 are defined as essential elements for proving the transaction. Non-essential elements include customer name 218, since given the inclusion of customer account 216 as essential information, customer name 218 is not necessary to prove the transaction.

Instead of the vendee filling out an on-line transaction document 200, a vendor's representative can also fill out a transaction document 200 for the vendee. For example, a vendee can contact a vendor's sales representative by phone, and direct the vendor's sales representative to fill out a transaction document 200.

Referring back to FIG. 1, the verification process proceeds from block 104 to block 106, where the transaction elements are extracted from the transaction document 200. In a typical embodiment, the transaction elements are extracted to a computer memory of the vendor's computer for processing. The vendor can optionally perform certain back office processing on the transaction elements, such as credit card verification, available funds checking, and margin account purchasing approval.

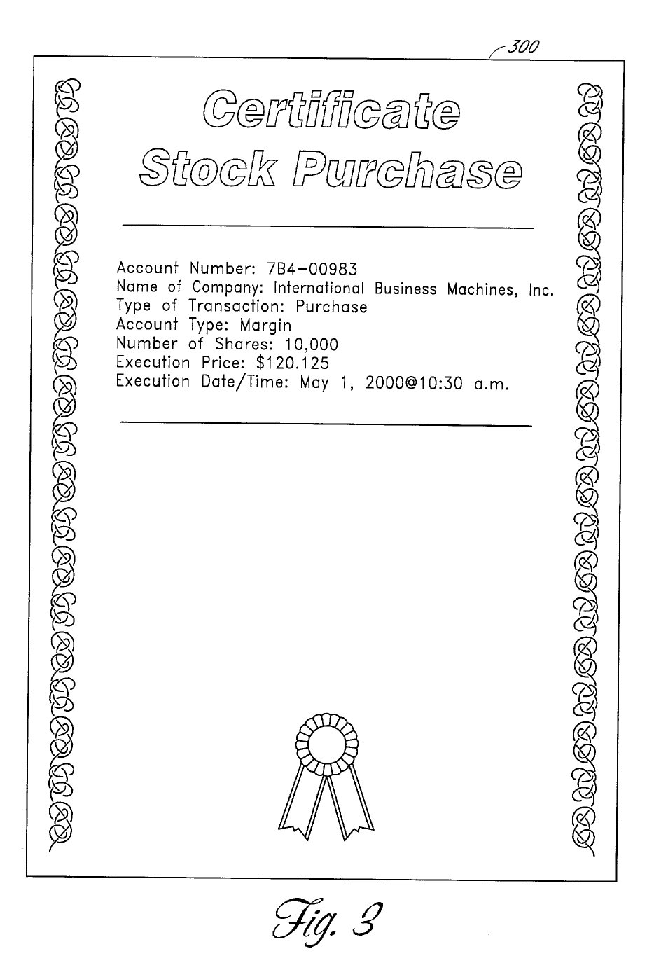

The verification process proceeds to block 108, where all or a subset of the transaction elements are attached to a certificate template 300 (FIG. 3). The transaction elements attached to the certificate template at block 108 are not encrypted with the vendor's private key, therefore the unencrypted elements are not used to verify that the content originated from the vendor. However, the unencrypted content allows a person viewing the certificate template 300 to have a sense of what the certificate template 300 includes. In one embodiment, only the non-essential elements are attached to the certificate template 300, since the essential elements will be encrypted and attached to the certificate template 300. The certificate template 300 is an electronic document, but can also be produced as a hard copy. The certificate template 300, before elements are attached to it, can be a blank document, or a document with ornamental features and the like that give rise to the official nature of a consummated transaction. See FIG. 3 to view one embodiment of a certificate template 300, with part or all of transaction elements attached to it by the process of block 108.

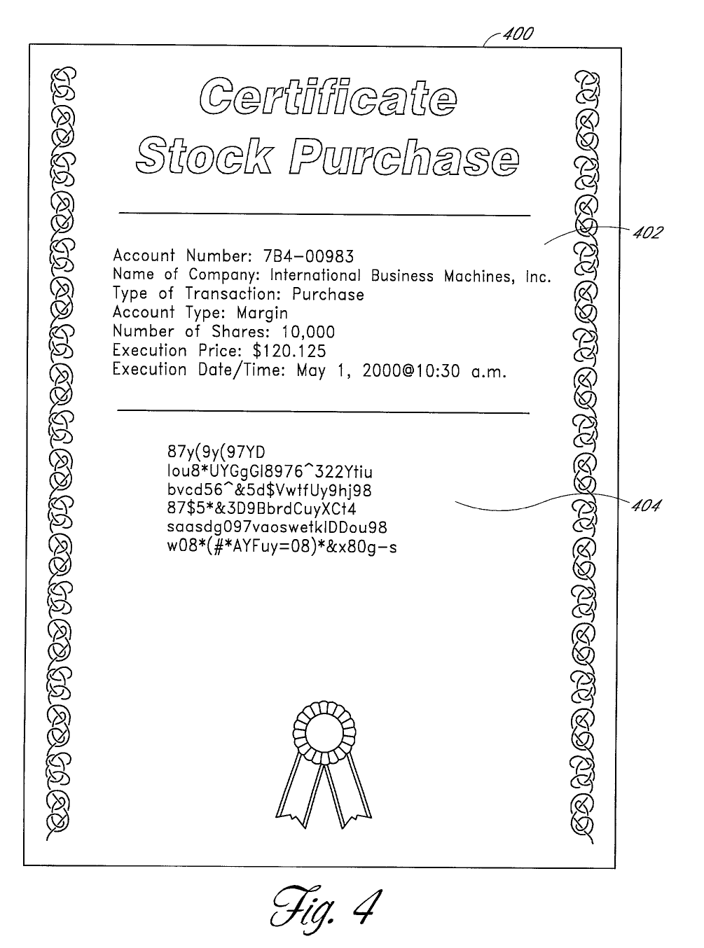

Referring back to FIG. 1, the verification process proceeds to block 110, where the essential elements are encrypted. In another embodiment, non-essential elements may also be encrypted. In one embodiment, the essential transaction elements are encrypted by a first PKI encryption algorithm. A detailed description of PKI algorithms is provided at pp.273-320 of Applied Cryptography. Using a PKI algorithm, the essential transaction elements are encrypted with the private key of the vendor. In one embodiment, an element of the current date and time is added to the essential elements to be encrypted, to ensure that the resulted encrypted essential elements are unique. The inclusion of the date and time element prevents parties from creating copies of the encrypted essential elements as bogus transactions. The inclusion of the date and time element also enables parties to distinguish legitimate transactions that are based on the same essential terms. The verification process then proceeds to block 112, where the encrypted essential transaction elements (and optionally some or all of encrypted non-essential elements) are attached to the certificate template 300. The certificate template 300 with the encrypted essential elements attached is referred to as a transaction certificate 400 (FIG. 4).

FIG. 4 illustrates one embodiment of a transaction certificate 400. The transaction certificate 400 includes non-encrypted elements 402, and encrypted essential elements 404.

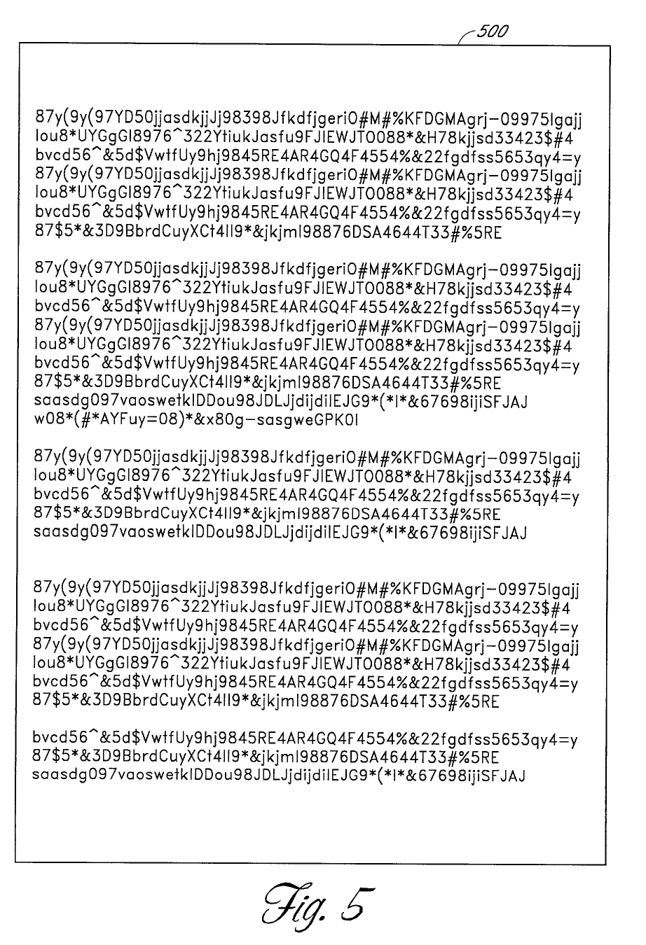

Referring back to FIG. 1, the verification process proceeds from block 112 to block 114, where the transaction certificate 400 is encrypted to generate an encrypted transaction certificate 500 (FIG. 5). In one embodiment, the transaction certificate 400 is encrypted by a second PKI encryption algorithm using the vendee's public key. The vendee's public key can be retrieved by the vendor from a central public key storage facility, or from the vendee. The second PKI encryption algorithm can be identical to or different from the first PKI encryption algorithm. FIG. 5 illustrates one embodiment of an encrypted transaction certificate 500. The encrypted transaction certificate 500 typically consists of human unreadable string of symbols. The verification process proceeds to block 116, where the encrypted transaction certificate 500 is transmitted from the vendor to the vendee. The encrypted transaction certificate 500 can be sent to the vendee by E-mail attachment using SMTP, POP3, MAPI or other E-mail protocols, or by sending a hyperlink to a Uniform Resource Locator (URL) through an established Internet protocol, such as Hyper Text Transfer Protocol (HTTP). The vendee can then receive the encrypted transaction certificate 500 by linking to the URL. The encrypted transaction certificate 500 can also be copied to a detachable data storage medium such as a floppy disk or an optical disk and sent to the vendee by a governmental postal service or a private package delivery service.

Referring again to FIG. 1, the verification process proceeds to block 118, where the encrypted transaction certificate 500 is received by the vendee and decrypted by a second PKI decryption algorithm using the vendee's private key. The decryption of block 118 produces the transaction certificate 400, which includes the now human readable non-encrypted elements 402, and the still encrypted elements 404. The vendee is now able to review the non-encrypted elements 402. The verification process proceeds to block 120, where the encrypted essential elements 404 are decrypted by a first PKI decryption algorithm using the vendor's public key. The first PKI decryption algorithm can be identical to or different from the second PKI decryption algorithm. The vendor's public key can be retrieved by the vendee from a central public key storage facility, or from the vendor. A public key can be certified using a public-key certificate, which is the public key (and optionally information about the key owner) signed by a certifying authority. The vendee is now able to verify that the encrypted transaction certificate 500 originated from the vendor, and that the essential elements have not been altered. In one embodiment, if the decrypted essential elements appear in a human readable form, the vendee may safely assume that the essential elements originated from the vendor and have not been altered. In another embodiment, in addition to verifying that the decrypted essential elements are now in human readable form, the vendee also verifies that the decrypted essential elements are consistent with the non-encrypted elements 402. Since the non-encrypted elements 402 may include all or part of the essential elements, the vendee can compare the essential elements in the non-encrypted elements 402 with the essential elements decrypted by block 120. The verification process proceeds to an end block 122.

In many non-critical situations, the vendee usually does not need to perform block 120's decryption of essential elements, because the transaction certificate 400 includes sufficient human readable content in elements 402. In these situations, block 120 can be performed only when the transaction is disputed by one of the parties.

The transaction certificate 400 can be produced by the vendor as a hard copy and delivered to the vendee. In one embodiment, the vendor omits block 114's encrypting of the transaction certificate 400, and places the transaction certificate 400 in a sealed envelope to be delivered to the vendee, for example by a government postal service or a private package delivery service. In one embodiment, the vendor prints the encrypted essential elements in a clean and clear manner onto the transaction certificate 400, with large fonts and sufficient spacing in order to facilitate the vendee's correct scanning of the encrypted essential elements. The vendee opens the sealed envelope to review the transaction certificate 400. Block 118's decrypting of the encrypted transaction certificate 500 is also omitted. The vendee can also receive the transaction certificate 400 in electronic form, and produce a hard copy of the transaction certificate 400. The encrypted essential elements on a hard copy transaction certificate 400, or the entire hard copy transaction certificate 400, can be converted back to electronic form using a scanner. Recognition algorithms such as optical character recognition, intelligent character recognition, optical mark recognition and so forth can be used to recognize the images of the encrypted essential elements 404. Once converted into electronic form, the encrypted essential elements 404 can be decrypted by the vendee or a third party, with the vendor's public key.

In another embodiment in which the transaction certificate 400 is sent to the vendee in electronic form, the vendor and the vendee are not concerned with preventing unauthorized parties from viewing the transaction certificate 400, therefore the encrypting and decryption of block 114 and block 118 are omitted. The encrypted essential elements 404 are included in the transaction certificate 400 to allow the vendee to verify the transaction.

Computer Programs

A vendor-side computer program can be used by the vendor to automate the vendor actions described above in connection with FIG. 1. The program identifies essential elements and non-essential elements on a transaction document 200 to be filled out by the vendee. The program attaches some or all of the transaction elements of the transaction document 200 to a certificate template 300, encrypts essential elements, attaches the encrypted essential elements to the certificate template 300, encrypts the transaction certificate 400 which includes the encrypted essential elements, and sends the encrypted transaction certificate 500 to the vendee.

A vendee-side computer program can be used by the vendee to automate the vendee actions described above in connection with FIG. 1. After the vendee fills out the transaction document 200, the program submits the transaction document 200 to the vendor, and receives an encrypted transaction certificate 500 from the vendor. The program decrypts the encrypted transaction certificate 500 to produce a transaction certificate 400 that includes encrypted essential elements. In one embodiment, the program automatically decrypts the essential elements. In another embodiment, the program waits for vendee's instruction to decrypt the essential elements. The vendee need not decrypt the essential elements unless the vendee wishes to verify the transaction. The vendee-side program can also be used to send the transaction certificate 400 to a third party for authentication.

The vendor-side program and the vendee-side program can be designed to work in cooperation. In one embodiment, in addition to sending the encrypted transaction certificate 500, the vendor-side program also sends the vendor's public key to the vendee, or sends an instruction to retrieve the vendor's public key from a central public key storage facility. The vendor-side program can also send an identification to the first decryption algorithm or the source code of the first decryption algorithm to the vendee. The identification of an algorithm identifies an algorithm whose source code is available to the vendee. In another embodiment, in addition to submitting the filled-out transaction document 200, the vendee-side program also sends the vendee's public key to the vendor, or sends an instruction to retrieve the vendee's public key from a central public key storage facility. The vendee-side program can also send an identification to the second encryption algorithm or the source code of the second encryption algorithm to the vendor. In yet another embodiment, the vendee uses the vendee-side program to define the essential elements in the transaction document 200. The vendee-side program then submits the element definitions along with the transaction document 200 to the vendor. The vendor-side program then identifies the vendee-defined essential elements as essential elements.

Third Party Authentication

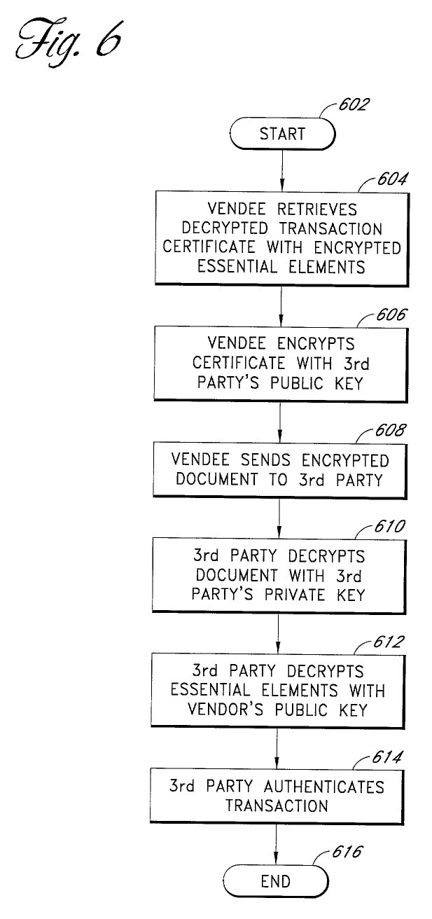

FIG. 6 illustrates one embodiment of an authentication process of using a third party to authenticate the transaction. The third party can be a judge, an arbitrator, a mediator, a government agency, a credit bureau, or any other person or organization that authenticates transactions or resolves disputes. The authentication process starts from a start block 602 and proceeds to block 604. At block 604, the vendee retrieves the decrypted transaction certificate 400, which has been decrypted at block 118 of FIG. 1. The decrypted transaction certificate 400 still includes the encrypted essential elements 404. Referring back to block 120 of FIG. 1, the decrypted essential elements are placed in a document separate from the transaction certificate 400, or a new copy of the transaction certificate 400, so that the original decrypted transaction certificate 400 can be used for the authentication process.

Referring again to FIG. 6, the authentication process proceeds to block 606, where the vendee encrypts the transaction certificate 400, for example using a third PKI algorithm and based on the third party's public key. The third PKI encryption algorithm can be identical to or different from the first or second PKI encryption algorithm described above in connection with FIG. 1. The authentication process proceeds to block 608, where the encrypted document is sent to a third party for authentication. The authentication process proceeds to block 610, where the third party receives the document and decrypts the document, for example using the third party's private key and a third PKI decryption algorithm. The third PKI decryption algorithm can be identical to or different from the first or second PKI decryption algorithm. The decryption of block 610 produces the decrypted transaction certificate 400 retrieved at block 604.

The authentication process then proceeds to block 612, where the third party retrieves the vendor's public key from the vendor directly or from a central public key storage facility, and decrypts the encrypted essential elements of the transaction certificate 400 with the vendor's public key, using the first PKI decryption algorithm. The authentication process proceeds to block 614, where the third party reviews the transaction certificate 400 and the essential elements and authenticates the transaction. Since the encrypted essential elements are successfully decrypted with the vendor's public key, it is inferred that the essential elements were encrypted with the vendor's private key. It is thus further inferred that the essential elements were encrypted by the vendor. Therefore, the transaction is verified as originating from the vendor and including the essential elements. The authentication process proceeds to an end block 616.

In another embodiment in which the vendee is not concerned with maintaining the communication between the vendee and the third party private, the encryption and decryption of block 606 and block 610 can be omitted. For example, the vendee can submit to the third party a copy of the transaction certificate 400 with the encrypted essential elements, as a hard copy or an electronic copy. If a hard copy of the transaction certificate 400 is delivered to the third party, the third party scans the transaction certificate 400 to convert the encrypted essential elements to electronic form, and decrypts the essential elements based on the vendor's public key, to authenticate the transaction.

Vendor Modules and Vendee Modules

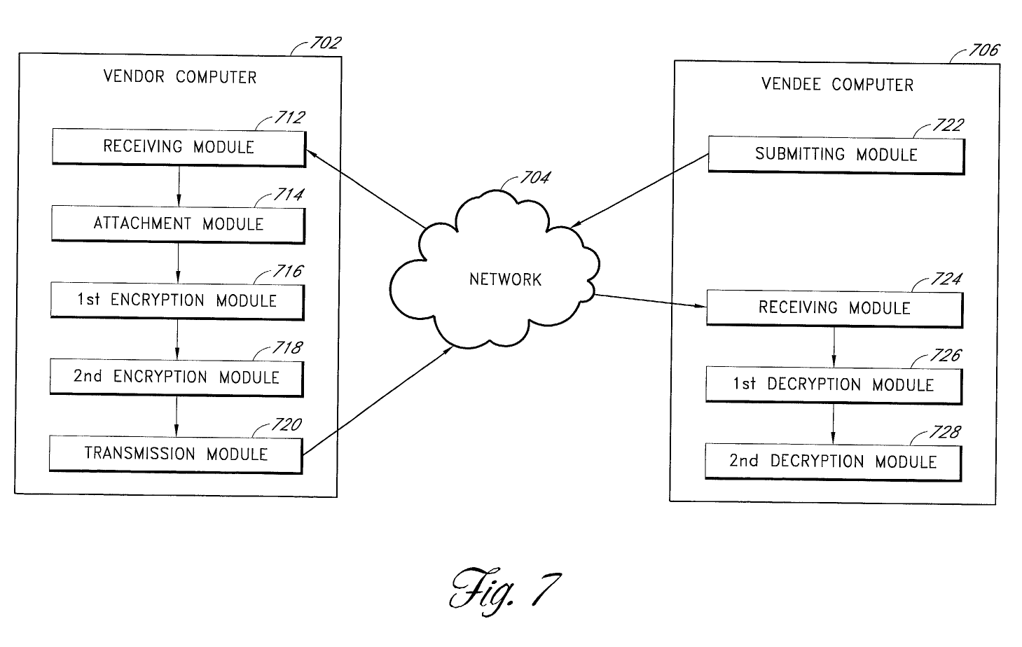

FIG. 7 illustrates one embodiment of a vendor computer 702 and a vendee computer 706. The vendor computer 702 communicates with the vendee computer 706 through a communications network 704. A computer may be any processor controlled device that permits access to a computer network, including terminal devices, such as personal computers, workstations, servers, clients, mini-computers, main-frame computers, laptop computers, a network of individual computers, mobile computers, palm-top computers, hand-held computers, set top boxes for a television, other types of web-enabled televisions, interactive kiosks, personal digital assistants, interactive or web-enabled wireless communications devices, mobile web browsers, or a combination thereof. The computers may further possess one or more input devices such as a keyboard, mouse, touch pad, joystick, pen-input-pad, and the like. The computers may also possess an output device, such as a visual display and an audio output. The network 704 can be a network or combination of networks spanning any geographical area, such as a local area network, wide area network, regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communication services (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

Referring to FIG. 7, a submitting module 722 of the vendee computer 706 submits a filled-out transaction document, such as the transaction document 200, to the vendor computer 702. The term “module”, as used in the application, refers to computer readable instructions in the form of software, hardware, firmware, or combinations of the above. A receiving module 712 of the vendor computer 702 receives the transaction document 200. An attachment module 714 of the vendor computer 702 attaches some or all of the transaction elements of the transaction document 200 to a certificate template, such as the certificate template 300. In one embodiment, none of the transaction elements are attached to the certificate template 300, and the certificate template 300 is a blank document or a document with symbols such as an official seal. A first encryption module 716 of the vendor computer 702 encrypts the essential elements using the vendor's private key, and attaches the encrypted essential elements to the certificate template 300 to produce a transaction certificate, such as the transaction certificate 400. The second encryption module 718 of the vendor computer 702 encrypts the transaction certificate 400 using the vendee's public key to produce an encrypted transaction certificate, such as the encrypted transaction certificate 500. A transmission module 720 of the vendor computer 702 sends the encrypted transaction certificate 500 to the vendee computer 706.

A receiving module 724 of the vendee computer 706 receives the encrypted transaction certificate 500. A first decryption module 726 of the vendee computer 706 decrypts the encrypted transaction certificate 500 using the vendee's private key to produce the transaction certificate 400. A second decryption module 728 of the vendee computer 706 decrypts the encrypted essential elements using the vendor's public key. The receiving module 724, the first decryption module 726 and the second decryption module 728 can be integrated into a viewing program, such as an email program. Upon the receiving module's 724 receiving an encrypted transaction certificate 500, the viewing program automatically uses the first decryption module 726 to decrypt the encrypted transaction certificate 500 into transaction certificate 400, and display the transaction certificate 400 to the vendee. In one embodiment, the viewing program also automatically uses the second decryption module 728 to decrypt the encrypted essential elements and display the decryption results to the vendee.

Conclusion

Specific blocks, sections, devices, functions, processes and modules may have been set forth. However, one skilled in the art will recognize that there are many ways to partition the system of the present invention, and that there are many parts, components, modules, processes or functions that may be substituted for those listed above.

This invention may be embodied in other specific forms without departing from the essential characteristics as described herein. The embodiments described above are to be considered in all respects as illustrative only and not restrictive in any manner. The scope of the invention is indicated by the following claims rather than by the foregoing description.

What is claimed is:

1. A method of verifying a transaction conducted between a first party and a second party, the method comprising:
receiving transaction elements of the transaction;
identifying at least a portion of the received transaction elements as selected elements;
encrypting the selected elements based on a private key of the first party to generate an encrypted code;
printing at least a portion of the received transaction elements on a hard copy transaction certificate;
printing the encrypted code on the hard copy transaction certificate;
sending the transaction certificate with the encrypted code to the second party; and
instructing the second party to scan the transaction certificate to convert the encrypted code to electronic form, and to decrypt the encrypted code in electronic form based on a public key of the first party to generate decrypted selected elements,
wherein the decrypted selected elements can be used by the second party to prove the transaction.

2. The method of claim 1, further comprising:
prompting the second party to enter transaction elements of the transaction on an electronic transaction document;
wherein receiving transaction elements comprises receiving transaction elements entered by the second party on the electronic transaction document.

3. The method of claim 1, further comprising identifying an element of a current date and time as one of the selected elements.

4. A method of verifying a transaction conducted between a first party and a second party, the method comprising:
receiving transaction elements of the transaction;
identifying at least a portion of the received transaction elements as selected elements;
attaching at least a portion of the received transaction elements to a certificate template;
encrypting the selected elements based on a private key of the first party to generate an encrypted code;
attaching the encrypted code to the certificate template to produce a transaction certificate;
transmitting the transaction certificate with the encrypted code to the second party; and
instructing the second party to decrypt the encrypted code of the transaction certificate based on a public key of the first party to generate decrypted selected elements,
wherein the decrypted selected elements can be used by the second party to prove the transaction.

5. The method of claim 4, further comprising:
prompting the second party to enter transaction elements of the transaction on an electronic transaction document;
wherein receiving transaction elements comprises receiving transaction elements entered by the second party on the electronic transaction document.

6. The method of claim 4, wherein transmitting the transaction certificate comprises sending the transaction certificate to an email address of the second party.

7. The method of claim 4, wherein transmitting the transaction certificate comprises sending an URL of the transaction certificate to an email address of the second party.

8. The method of claim 4, further comprising identifying an element of a current date and time as one of the selected elements.

9. A method of verifying a transaction conducted between a first party and a second party, the method comprising:
receiving transaction elements of the transaction;
identifying at least a portion of the received transaction elements as selected elements;
attaching at least a portion of the received transaction elements to a certificate template;
encrypting the selected elements based on a private key of the first party to generate an encrypted code;
attaching the encrypted code to the certificate template to produce a transaction certificate;
retrieving a public key of the second party;
encrypting the transaction certificate based on the retrieved public key of the second party, to generate an encrypted transaction certificate;
transmitting the encrypted transaction certificate to the second party;
instructing the second party to decrypt the transmitted encrypted transaction certificate based on a private key of the second party, to produce a decrypted transaction certificate that includes the encrypted code; and
instructing the second party to decrypt the included encrypted code based on a public key of the first party to generate decrypted selected elements,
wherein the decrypted selected elements can be used by the second party to prove the transaction.

10. The method of claim 9, further comprising:
prompting the second party to enter transaction elements of the transaction on an electronic transaction document;
wherein receiving transaction elements comprises receiving transaction elements entered by the second party on the electronic transaction document.

11. The method of claim 9, wherein transmitting the encrypted transaction certificate comprises sending the encrypted transaction certificate to an email address of the second party.

12. The method of claim 9, wherein transmitting the encrypted transaction certificate comprises sending an URL of the encrypted transaction certificate to an email address of the second party.

13. The method of claim 9, further comprising identifying an element of a current date and time as one of the selected elements.

14. A method of verifying a transaction conducted between a first party and a second party, the method comprising:
transmitting transaction elements of the transaction to the first party;
receiving a hard copy transaction certificate that includes an encrypted code;
scanning the received transaction certificate to convert the encrypted code to electronic form;
retrieving a public key of the first party; and
decrypting the converted encrypted code based on the retrieved public key of the first party to generate decrypted proof elements,
wherein the decrypted proof elements are used to prove the transaction.

15. A method of verifying a transaction conducted between a first party and a second party, the method comprising:
transmitting transaction elements of the transaction to the first party;
receiving a transaction certificate that includes an encrypted code;
retrieving a public key of the first party; and
decrypting the included encrypted code based on the retrieved public key of the first party to generate decrypted proof elements,
wherein the decrypted proof elements are used to prove the transaction.

16. A method of verifying a transaction conducted between a first party and a second party, the method comprising:
making a public key of the second party available to the first party;
transmitting transaction elements of the transaction to the first party;
receiving an encrypted transaction certificate;
decrypting the received encrypted transaction certificate based on a private key of the second party so as to generate a transaction certificate with an encrypted code;
retrieving a public key of the first party; and
decrypting the encrypted code based on the retrieved public key of the first party to generate decrypted proof elements,
wherein the decrypted proof elements are used to prove the transaction.

17. A method of a third party authenticating a transaction conducted between a first party and a second party, the method comprising:
receiving a hard copy transaction certificate with an encrypted code;
scanning the received transaction certificate to convert the encrypted code into electronic form;
retrieving a public key of the first party;
decrypting the converted encrypted code based on the retrieved public key of the first party to generate decrypted proof elements; and
declaring the transaction including the decrypted proof elements as authenticated if the decrypting is successful.

18. A method of a third party authenticating a transaction conducted between a first party and a second party, the method comprising:
receiving a transaction certificate with an encrypted code;
retrieving a public key of the first party;
decrypting the encrypted code based on the retrieved public key of the first party to generate decrypted proof elements; and
declaring the transaction including the decrypted proof elements as authenticated if the decrypting is successful.

19. A method of a third party authenticating a transaction conducted between a first party and a second party, the method comprising:
receiving an encrypted transaction certificate;
decrypting the received encrypted transaction certificate based on a private key of the third party so as to generate a transaction certificate with an encrypted code;
retrieving a public key of the first party;
decrypting the encrypted code based on the retrieved public key of the first party to generate decrypted proof elements; and
declaring the transaction including the decrypted proof elements as authenticated if the decrypting is successful.

20. A computing device for verifying a transaction conducted between a first party and a second party, the device comprising:
a receiving module configured to receive transaction elements of the transaction from the second party;
an attachment module configured to attach at least a portion of the received transaction elements to a certificate template;
a first encryption module configured to identify at least a portion of the received transaction elements as selected elements, to encrypt the selected elements based on a private key of the first party to generate an encrypted code, and to attach the encrypted code to the certificate template to produce a transaction certificate; and
a transmission module configured to transmit the transaction certificate from the first party to the second party,
wherein the encrypted code attached to the transaction certificate can be decrypted by the second party to prove the transaction.

21. A computing device for verifying a transaction conducted between a first party and a second party, the device comprising:
a receiving module configured to receive transaction elements of the transaction from the second party;
a first encryption module configured to identify at least a portion of the received transaction elements as selected elements, to encrypt the selected elements based on a private key of the first party to generate an encrypted code, and to attach the encrypted code and at least a portion of the received transaction elements to a transaction certificate;
a second encryption module configured to encrypt the transaction certificate based on a public key of the second party to generate an encrypted transaction certificate; and
a transmission module configured to transmit the encrypted transaction certificate from the first party to the second party,
wherein the encrypted transaction certificate can be decrypted by the second party based on a private key of the second party to generate a decrypted transaction certificate with the encrypted code, wherein the encrypted code can be decrypted based on a public key of the first party to generate decrypted selected elements, and wherein the decrypted selected elements can be used to prove the transaction.

22. A computing device for verifying a transaction conducted between a first party and a second party, the device comprising:
a submitting module configured to submit transaction elements of the transaction from the second party to the first party;
a receiving module configured to receive a transaction certificate including an encrypted code from the first party to the second party; and
a first decryption module configured to decrypt the encrypted code to generate decrypted proof elements, based on a public key of the first party,
wherein the decrypted proof elements are used to prove the transaction.

23. A computing device for verifying a transaction conducted between a first party and a second party, the device comprising:
a submitting module configured to submit transaction elements of the transaction from the second party to the first party;
a receiving module configured to receive an encrypted transaction certificate from the first party to the second party;
a first decryption module configured to decrypt the received encrypted transaction certificate, based on a private key of the second party, to generate an decrypted transaction certificate with an encrypted code; and
a second decryption module configured to decrypt the encrypted code based on a public key of the first party to generate decrypted proof elements,
wherein the decrypted proof elements are used to prove the transaction.
